(19) United States
(12) Patent Application Publication
(10) Pub. No.: US 2014/0074666 A1
(43) Pub. Date: Mar. 13, 2014

(54) "Purchase by Chapter," a Method of Electronic Point of Sale of Digital Content

(71) Applicant: Lesley Jacqueline Simons, Los Angeles, CA (US)

(72) Inventor: Lesley Jacqueline Simons, Los Angeles, CA (US)

(21) Appl. No.: 13/610,892

(22) Filed: Sep. 12, 2012

(51) Int. Cl. G06Q 30/00

(52) U.S. Cl. 705/27.2

(57) ABSTRACT

A method of commerce for books, including ebooks and audiobooks, in digital format. Each book is offered for sale chapter-by-chapter, alongside the option to purchase the book as a unit. The publisher or etailer divides the book with digital metadata to enable chapter-by-chapter display and commerce on the book's sales webpage. The book may or may not be a textbook. The book can be copyrighted. The sales page can be presented to a general audience without need of a special ereader or subscription. Options presented to the consumer can include temporary access as well as a permanent download. Temporary access can be provided by streaming audio or a password-protected webpage or read-only file. Unlimited temporary access may be offered as part of a pre-paid subscription.

### 1. FIELD OF THE INVENTION

This invention is in the field of online commerce, specifically point of sale systems for digital content containing text, images, and audio for personal consumption.

### 2. BACKGROUND OF THE INVENTION

The world wide web has revolutionized the music industry. A primary example is the availability of single songs for sale. In the age of cassette tapes and CD's, the recording media did not lend themselves well to single sales. When a listener liked a particular song, she often had to buy the entire album, thus paying a high price for her favorite song padded by several “filler” songs that she didn't care about. That changed when music content went online Most artists now offer consumers the choice to sample and download individual songs from each album. Consumers enjoy the freedom to focus their purchasing power on their favorite tracks. Artists benefit by selling more of their most popular songs, sales from casual fans that may not have occurred at all if listeners had to purchase the entire album.

Most other forms of digital content have not taken the step of making themselves widely and easily available for sale in sub-units. Books are easily divisible into chapters, so why don't we have the option of buying books one chapter at a time? When major online booksellers such as Amazon® appeared in the mid-1990's, they were still in the business of selling hardcopy books. It is not possible to offer individual chapters of printed books. Nowadays, it is easier to publish new books in electronic format than in print. A chapter-by-chapter feature would be entirely feasible and sensible in today's book market.

This method of commerce could have advantages for buyers and sellers alike. A fan of a best-selling novel could spread out the expense of a costly book. Authors and publishers could experiment with a 21^{st}-century form of serial publication, as was successful for Charles Dickens and Sir Arthur Conan Doyle. In non-fiction, a reader may be more interested in some chapters than others. Perhaps someone with an interest in studying the life of Abraham Lincoln could download Lincoln's chapter from a book of presidents instead of purchasing an entire book about Lincoln or all the presidents. Books of short stories, poetry, recipes, how-to instructions, etc. lend themselves naturally to sub-unit sale. Publishers and artists would benefit by moving extra quantities of their most popular sub-units, which customers otherwise would not purchase for the price of the whole unit. This would also allow booksellers to become more competitive against publishers of more dynamic content, where articles, blogs, and newsletters can be made cheaply and quickly, and distributed widely. All of these arguments work just as well for picture books and audio books.

My invention takes that step. “Purchase by Chapter” will enable consumers to pay for only what they need. It will also serve as a “pay as you go” option for those lacking the resources to buy a whole book(s) at one time. Primary uses would include non-fiction, textbooks and how-to guides, collections of short stories and poetry, scripts, recipe books, and audiobooks, though the application will extend to all literary forms, and other media. In the best mode, I envision a system where a consumer can log on to a readily available online publisher or etailer and have the option to purchase a book one chapter at a time as an alternative to purchasing the entire book at once. The same consumer can search for audio books, picture books and maps, and stream and/or download them in sub-units, not having to commit to a whole book if so desired.

### 2.1. Description of Related Technology

As described above, technology for purchasing musical albums track-by-track is well known. There are many websites that offer individual sheet music downloads, such as OnlineSheetMusic.com, SheetMusicArchive.net, and 8notes.com. The applications envisioned herein will be primarily for books, whether in written or spoken form. I will make no claims regarding musical content and therefore need not discuss the existing technology in that field.

There are a few commercial products and U.S. Patents in this general field.

Inkling® is a new San Francisco-based company devoted to publishing etextbooks on iPads®. In a blog dated Feb. 13, 2012, Inkling's® VP of marketing posted “Save money: Like buying songs online, it's easy to buy individual chapters of an Inkling textbook. Professors can create chapter playlists, while students save money.” (http://www.inkling.com/news/). This feature was also described in a 2011 article by a third party, which observed:

“But if you don't already have a tablet or e-reader, don't really want one, and need to read most of a textbook, it might still make sense to just buy the hardback. Right now Inkling is still a pretty small venture. This fall they'll only offer 100 textbooks as e-books.”

(http ://www.good.is/post/downloading-college-textbook-chapters-could-make-college-more-affordable/)

The major disadvantage of Inkling® is its narrow scope. It is only available specifically for textbooks, and only through iPads®. The service does not offer a platform that could be used on general-purpose computers, or for a broader variety of books or media.

The co-founders of Inkling® have one patent application pending, “Methods for Sequencing Electronic Media Content,” United States Patent Application 2012/0102395, filed in 2010 and published in April, 2012. This patent expressly “contemplate[s] use of an electronic reading device” for the formatting of “educational electronic media content.” This patent application does not contain the word “chapter.” It does disclose “dividing the educational electronic media content into a plurality of media objects in a manner that is not absolutely constrained to be the same as a publisher's original division of content into particular sections and pages.” This feature is for the purpose of display and navigation of the contents, not sale of the book.

CengageBrain is an etextbook publisher that has been available on the web for some time. Their format options now include eBooks as well as eChapters: “New eReader format! Single chapters for as low as $1.99.” (http://www.cengagebrain.com/shop/index.html)

As with Inkling®, CengageBrain's option to purchase individual chapters is only available on a particular, specialized eReader, which in this case is the publisher's own proprietary reader. The company's “CourseSmart”® program online provides access only to entire textbooks.

Ebrary® is a company that provides high-volume access to ebook titles, to institutions such as schools and libraries. This company offers the option to print or save any excerpt of an ebrary® book to a PDF file:

“You can create an image PDF of a specific chapter or page range for any ebrary document (up to the same number of pages you can print on your ebrary site). You can then read the image PDF file offline using any standard PDF viewer, such as Adobe Reader, which most users already have. You can also transfer the file to a mobile device or ereader, including the Amazon Kindle.” (http://support.ebrary.com/kb/download-type-1/, August, 2012).

There are two major disadvantages to the ebrary® system. First is accessibility. It is not available to the general public. This is a service that an institution such as a library, museum, or university can subscribe to, and then a member of the library can access ebrary® at that institution. As such, it is not valuable to publishers as a method of doing business. Second, ebrary® is limited to print material, as opposed to audio/video content.

The website BooksShouldBeFree.com offers free chapter-by-chapter downloads of audiobooks in the public domain. The consumer can stream or download each chapter, or download all individual chapters as zip files. Again, this platform is not available to publishers of currently copyrighted material, so it is not viable as a method of doing business.

iTunes® offers software called “Chapter and Verse,” (http://lodensoftware.com/chapter-and-verse/) marketed primarily for downloading scripture from the bible. It allows the user to “combine multiple input files into a single audiobook file with chapter marks.” Chapters can “be added at regular intervals specified by the user.” A 2012 article in Salon.com describes a similar iTunes® feature. The author writes, “What the audiobooks don't have is chapter separations.” The consumer must set up her own chapters “using iTunes advanced setting options.” (http://techtips.salon.com/add-chapters-audiobooks-itunes-746.html).

Some publishers advertise the option of downloading a free chapter. However, this is a marketing idea more than a complete service—it is used to hook a consumer into buying the whole book.

Patent Application 2009/0037271 by Andrew Bayne discloses a system where the content vendor recommends one chapter. In this system, the customer first uses a retail website to purchase one or more books or movies in physical form, to be mailed to her home. If the customer purchases, say, a book, then the website makes a recommendation that the customer purchase one chapter of the book for immediate download and preview. The Bayne application does not anticipate an over-arching platform for marketing and selling chapters a priori. It would not allow the user to select her chapter(s) of preference, and would not sell chapters individually without sale of the entire book or movie.

U.S. Pat. No. 7,925,548 B2 by Alger and Guren, assigned to Microsoft®, describes a client portal that can be tailored to certain specific tasks such as purchasing eBooks. The portal has a “Preview” feature. Selecting “preview” would allow the customer to immediately download a preview of the book, “(e.g., a free copy of the first chapter).”

Similarly to the Bayne application, the Microsoft patent does not allow the consumer to select her chapter(s) of choice. The “preview” feature is a marketing technique for the entire book, not a method of sale for individual chapters.

### 2.2. Objects of the Invention

Despite the options available above, what is needed is a widespread, simple point-of-sale system where etailers offer commercial books for sale to the general public chapter-by-chapter. When a consumer considers purchasing a book at a mainstream etailer, she should see a list of the book's chapters, and should be able to purchase them immediately and individually in electronic format. This invention provides exactly that system. The service will be widely available to a general audience at their home computers, via open-access etailer websites, without need of a special eReader or subscription. It will be a valuable method of commerce for publishing and selling copyrighted books for profit, not just public domain material. The service will extend to a wider variety of materials than just textbooks. It will be available for multiple forms of digital content, including text, images, audio, and video.

### 3. SUMMARY OF THE INVENTION

The system is designed to integrate with the generic architecture common to existing Point of Sale applications on the internet. The technology of the internet, the world wide web, personal computers, ereaders, smartphones, and personal digital assistants or tablets are extremely well known in the art and need not be rehashed here.

For the purposes of this summary, the invention will be described as it applies to a “book” and its “chapters.” I define a book as a form of digital content consisting of text and / or images. It is to be understood that the invention works just as well for all forms of digital content. In its best mode, I envision the invention applying to books, ebooks, and audiobooks. I define an “ebook” as a digital form of content that includes text and/or images, and possibly other forms of content such as sound, video clips, applets, hyperlinks, markup language, etc. An ebook may be read on a general-purpose computer or an ereader, and it may be dynamic and interactive so as not to have a fixed appearance. I define an “audiobook” as a sound recording of the narration of a book. Generically, we can use the phrase “unit of content” to cover all instances of books, ebooks, audiobooks, and other digital content containing any combination of text, images, audio, video, and computer code. The generic term “sub-unit” can refer to a commercially viable sub-portion of a unit of content, such as a part, chapter, section, article, or story. The present invention is not intended to overlap with any known applications to purchasing musical content one track at a time from within an album, or to downloading textbooks one chapter at a time for viewing on a particular brand of ereader.

The word “publisher” will refer to the original source of copyrighted material, such as the author or publisher in the traditional sense. The word “consumer” will refer to the end purchaser or intended purchaser, generally an individual customer at her own computer. The word “etailer” will refer to the electronic retailer, the middleman between the publisher and the consumer. In the case of self-published works, the etailer will be the publisher.

The system of commerce begins when a digital version of the book is created, generally by the publisher but possibly by the etailer as well. The book contains a small amount of “metadata,” or information about the electronic parameters of the unit of content. This includes information about the division of the unit of content into parts, chapters, sections, etc. The metadata is either provided by the publisher to the etailer, or occasionally created by the etailer for purposes of posting the material to its website.

The protocols for metadata are already well established in the art. For example, ONIX for books is currently the preferred electronic method for communicating structured product metadata. Indexing and metadata for audiobooks are available in standardized databases defined by the Consumer Electronics Association and the Audio Publishers Association as the CEA-2003 standard for audiobook metadata.

Next, when the etailer sets up a sales page for the book, that profile page contains a list of the chapters. Prior to this invention, this option was sometimes allowed by showing a scanned image of the printed table of contents. However, the traditional table of contents was merely an image, not an electronically “live” screen with links. Under the new system, the metadata serves as a guide for a listing of the book's chapters. One or more of the chapters listed on the book's sales page is accompanied by links with the option to purchase that individual chapter. As metadata information is structured to support specific content segments, information may be separated, itemized and priced accordingly.

The “purchase” of a chapter can be temporary or permanent. A permanent purchase is a download of the chapter, a file that the consumer can store on her hard disk, eReader, or other memory device. The consumer will choose her format (e.g. PDF, eReader file, mobile) at the time of purchase.

A one-time or temporary purchase is analogous to “streaming” audio or video. It enables the consumer momentary access to the content without licensing her own copy. In the case of an audiobook, this is accomplished by streaming audio. In the case of a print book, the etailer can, for example, refer the consumer to a webpage containing a read-only version of the chapter, with safeguards against downloading or copying the material there. For instance, the webpage could only be accessed once, or protected with a subscription password that expires after a short period of time. The material could be displayed on a PDF file that cannot be downloaded. Alternatively, the file could be accessible in read-only format, encrypted with an expiration date. A temporary download to an eReader could be similarly encrypted to become inaccessible after one viewing or a short period of time. See, for example, http://www.booleserver.com, which discusses temporarily accessible files. It is understood that the temporary download feature is probably not 100% safeguarded against unauthorized copying by all determined consumers. However, it is mostly effective against unwanted copying and distribution, and is a generally less convenient method for the consumer to access the material. As such, the temporary purchase is justifiable at a lower price than the permanent download.

### 4. BRIEF DESCRIPTION OF THE DRAWINGS

FIG. 1 depicts the general flow of information, from publisher to consumer.

FIG. 2 shows a generic screenshot of a sales page, where the etailer displays the book and its chapters to the consumer.

FIG. 3 shows the details of content delivery from the etailer to the consumer.

### 5. DETAILED DESCRIPTION OF THE PREFERRED EMBODIMENTS

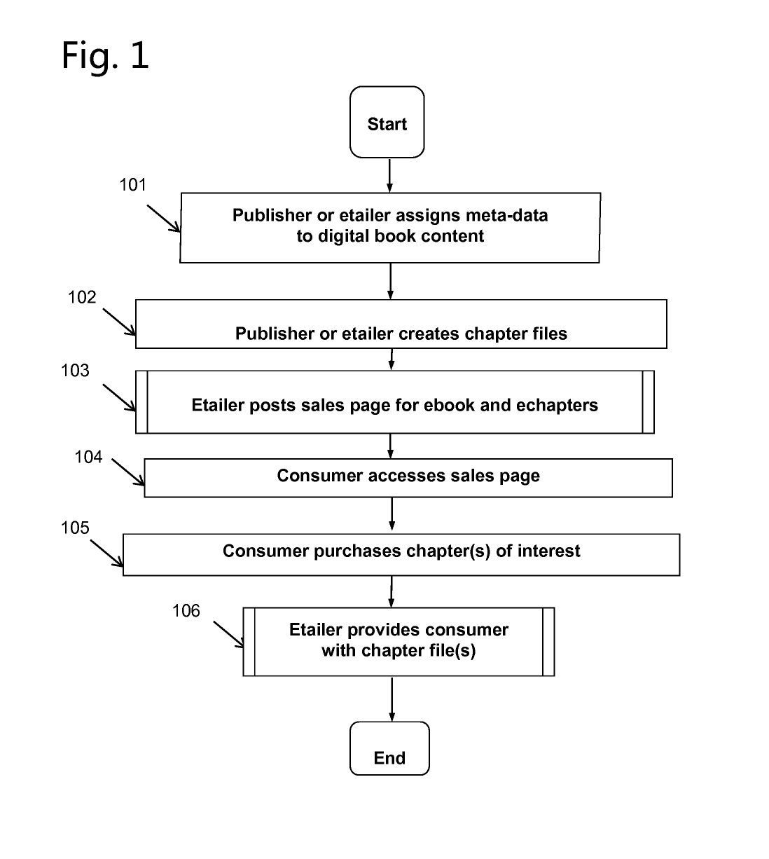

See FIG. 1 to follow the general flow of information through the commerce stream.

Formatting of a digital book or ebook can be performed by the publisher or etailer, 101. The formatting includes, at a minimum, the division of the book into chapters. At this stage, the book can still be a single file, with simple digital markers to indicate chapter breaks and the names of the chapters.

Based on the book's division into chapters, the publisher or etailer can then create separate files for each chapter that are ready for sale, 102.

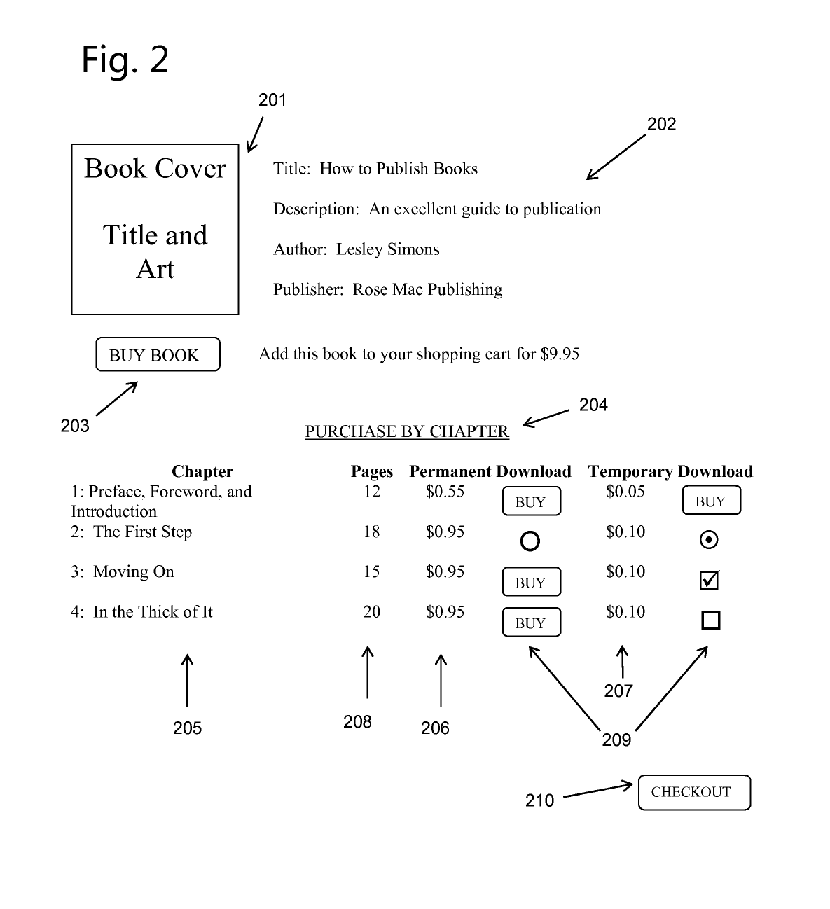

In step 103, the etailer creates a sales page for the book that includes click-to-buy links for the whole book as well as its individual chapters. This sales page will be discussed further below in reference to FIG. 2.

After the sales page is published, a consumer may access it from her own computer, mobile device, or eReader, 104. For instance, the consumer may search for the sales page by the name of the author or title of the work, the subject, or a list of recommendations provided by the publisher, based on the consumer's prior searches and purchases.

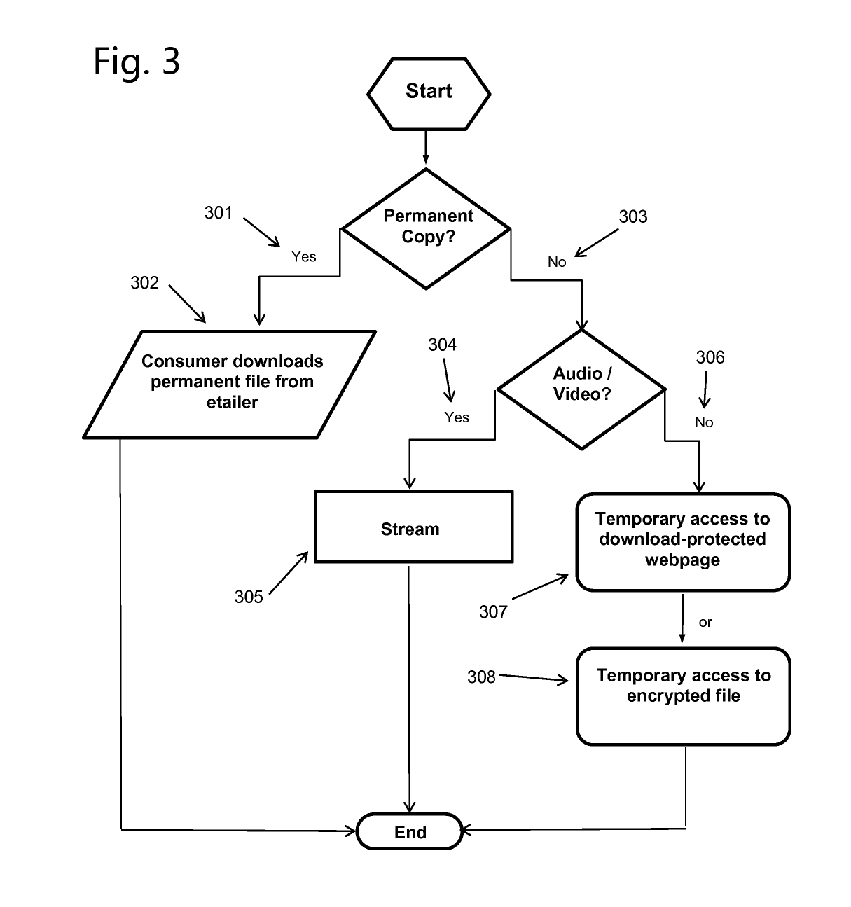

On the sales page, the consumer now has the option of purchasing individual chapters, 105. After checkout, the etailer delivers an electronic copy of the consumer's chosen chapter or chapters, 106. The process of content delivery is discussed in further detail below in reference to FIG. 3.

FIG. 2 is a generic screenshot of an etailer's sales page for a particular book. The page may feature the book title or cover, 201, along with vital information about the book, 202, and means of purchasing the entire book, 203, either in hardcopy format or as an ebook.

Sales pages of entire books are well known in the art and are not broadly claimed by this invention.

The sales page also features a “purchase by chapter” interface, 204. This interface includes a discrete list of all of the chapters that the etailer wishes to sell individually, 205. This may be a partial or complete list of all the chapters in the book. For instance, it might include only “best-seller” chapters. Each chapter may have its own listed price as a permanent download, 206, and/or a price as a temporary download, 207. The etailer may also wish to display other vital information for each chapter, 208, such as its length in pages, size in bytes, or duration in minutes and seconds. The listing for each chapter for sale displays means for purchasing the chapter, 208.

The listing for each chapter for sale includes a purchasing means for purchasing that chapter, 209. For the purposes of illustration, FIG. 2 shows a variety of examples of purchasing means. Each one could be a “Buy” button, a checkbox, radio button, or other similar means for the consumer to indicate that she wishes to purchase the chapter. Purchasing means for individual chapters may be accompanied by purchase consolidation means 210, such as an “Add to Cart,” “Complete Order,” or “Checkout” button.

Once the consumer has completed her purchase, the etailer delivers the content. This process is illustrated in FIG. 3. If the consumer selected a permanent copy 301, the etailer may simply offer the consumer the option of opening and downloading a copy on her own computer, ereader, or other electronic device, 302.

Temporary access to the chapter, 303, could be provided in a variety of ways. Technologically, in the case of audio or video 304, the chapter could be streamed to the consumer's computer, 305. This would allow the consumer to enjoy the content once as it plays, without the ability to save a copy to her own device's memory. In the case of text or images 306, the etailer could provide the consumer with a password providing temporary access to a website 307 or encrypted file 308. As a matter of business logistics, the etailer could sell the consumer a subscription service, offering unlimited access for a pre-paid monthly or annual fee.

I claim:

1. A method of commerce in digital content, comprising:
digitization of distinct units of content into digital form;
insertion of digital metadata into said digital form of each said unit of content, to divide each said unit of content into distinct subunits;
display by an etailer of each said unit of content onto an online sales page;
display of each said sub-unit on said sales page of said unit of content;
access by a consumer to said sales page;
selection by said consumer of one or more said sub-units;
payment by said consumer to said etailer for said sub-units; and
delivery by said etailer to said consumer of said sub-units.

2. The method of claim 1, wherein said sales page is available to the general public on the world wide web, without need of a dedicated eReader or paid subscription.

3. The method of claim 1, wherein said units of content are selected from the group consisting of books, ebooks, and audiobooks;

4. The method of claim 2, wherein said units of content are selected from the group consisting of books, ebooks, and audiobooks;

5. The method of claim 3, wherein said sub-units are chapters.

6. The method of claim 4, wherein said sub-units are chapters.

7. The method of claim 1, wherein said digital content is copyrighted.

8. The method of claim 2, wherein said digital content is copyrighted.

9. The method of claim 3, wherein said digital content is copyrighted.

10. The method of claim 4, wherein said digital content is copyrighted.

11. The method of claim 5, wherein said digital content is copyrighted.

12. The method of claim 6, wherein said digital content is copyrighted.

13. The method of claim 1, wherein said sales page presents the option to purchase said digital content in permanent or temporary form.

14. The method of claim 13, wherein said content is an audiobook, and each sub-unit is a chapter of said audiobook, and when a consumer selects a temporary purchase, said chapter is streamed to said consumer's computer.

15. The method of claim 13, wherein said content is a book, and each sub-unit is a chapter of said book, and when a consumer selects a temporary purchase, said chapter is provided on a temporary webpage protected from copying or download.

16. The method of claim 13, wherein said content is a book, and each sub-unit is a chapter of said book, and when a consumer selects a temporary purchase, said chapter is provided on a read-only file protected by a password with expiration date.

17. The method of claim 13, wherein said digital content is selected in said temporary form and is pre-paid.

18. The method of claim 13, wherein said digital content is copyrighted.

19. The method of claim 14, wherein said audiobook is copyrighted.

20. The method of claim 15, wherein said book is copyrighted.

21. The method of claim 16, wherein said book is copyrighted.

22. The method of claim 17, wherein said digital content is copyrighted.
